(19) United States
(12) Patent Application Publication
(10) Pub. No.: US 2014/0293612 A1
(43) Pub. Date: Oct. 2, 2014

(54) NOVEL LED WALL LAMP

(71) Applicant: Wen Chung TSAO, TAIPEI (TW)

(72) Inventor: Wen Chung TSAO, TAIPEI (TW)

(21) Appl. No.: 13/867,139

(22) Filed: Apr. 22, 2013

(30) Foreign Application Priority Data
Mar. 28, 2013 (CN) 201320147889.7

(51) Int. Cl. F21V 29/00; F21V 21/30

(52) U.S. Cl. CPC F21V 29/2206; F21V 21/30
USPC 362/297

(57) ABSTRACT

A novel LED wall lamp comprising a lamp frame and a base plate for installing electric parts is provided; said lamp frame is fixed on the base plate; a mounting plate is provided in said lamp frame; an LED light source is fixed on the front face of the mounting plate, while the back is provided with heat sinks exposed out of the lamp frame; the four sides of the mounting plate are provided with reflectors. The utility model preserves the contour and mounting means of the traditional wall lamp and dissipates heat generated by the LED light source out of the lamp frame through the heat sinks at intervals.

### BACKGROUND OF THE INVENTION

The utility model relates to the technical field of LED lamps, in particular to a novel LED wall lamp for outdoor lighting.

As a novel energy-saving light source, LEDs have been quickly accepted by lighting designers due to their advantages of high light efficiency, long service life and low heat radiation and have been widely applied in all fields concerning lighting and in the field of the outdoor wall lamps.

At present, outdoor LED wall lamps available on the market are usually manufactured by the following method:

The lamp frame of the traditional HID lamp or fluorescent lamp is used; the LED driver is placed at the space originally for electronic elements such as the ballast and trigger; the LED and optical components thereof are together fixed on the auxiliary radiator with heat conduction and heat dissipation functions; and then the heat is dissipated to the surface of the lamp through the auxiliary radiator. The lamp with such structure is designed by using the traditional HID or fluorescent lamp as the light source, and the light source itself of the traditional lamp does not generate bad effect when the temperature rises, so enough external heat dissipation surface area is not dedicatedly designed. However, one of the most important factors in application of LED is heat dissipation. The temperature of LED is required to be controlled to be in a normal working scope thereof; otherwise, overheating LED will cause serious light attenuation, and even greatly shorten the service life. Moreover, the optical components are designed according to the size and feature of the traditional light source. The traditional light source emits light in almost all directions and is located at the geometrical centre of the optical component; while the LED has a unique feature of emitting light in a single direction, and the light-emitting angle of the common large-power LED is about 120°. Thus, an LED equipped with such optical components fails to reach the original light distribution curve of the lamp and has relatively large light losses.

### BRIEF SUMMARY OF THE INVENTION

To overcome defects and solve problems in the prior art, the utility model provides a novel LED wall lamp which preserves the convenient fixing and installing mechanisms of the traditional wall lamp for facilitating installation by the user and contour of the traditional wall lamp and is of good heat dissipation.

The utility model is realized by the following technical scheme:

A novel LED wall lamp comprising a lamp frame and a base plate for installing electric parts is provided; said base plate is fixed on the wall; said lamp frame is fixed on the base plate; one side of said lamp frame is hinged with the base plate, while the other side is provided with a lug in threaded connection with the base plate; said lamp frame is cylinder with two closed ends and a hollowed interior; a mounting plate is provided in said lamp frame; the front face of the mounting plate is fixed with an LED light source; the back of said lamp frame is provided with dorsal fin-like heat sinks exposed out of the lamp frame; the four sides of the mounting plate are provided with reflectors; the lamp frame directly in the front of the LED light source has a light-emitting opening covered with a light-emitting hood; and a sealing ring is arranged at the joint between the light-emitting hood and light-emitting opening.

Said heat sinks are arranged at intervals.

Said heat sinks, mounting plate and lamp frame are integrally moulded or separated but firmly jointed.

Both said mounting plate and heat sinks are made of metal with high thermal conductivity.

The utility model has the following beneficial effects: the contour of the traditional wall lamp is preserved; the traditional wall lamp fixation means is adopted to facilitate replacement by the user; the heat generated by the LED light source is dissipated out of the lamp frame through the heat sinks at intervals, so the LED is kept in the environment at normal temperature.

### BRIEF DESCRIPTION OF THE DRAWINGS

FIG. 1 is an exploded view of the utility model.

FIG. 2 is schematic view of the overall installation structure of the utility model.

FIG. 3 is a structural view of the lamp frame of the utility model.

In figures: 1-base plate, 2-lamp frame, 3-reflector, 4-LED light source, 5-sealing ring, 6-light-emitting hood, 7-mounting plate, 8-heat sink.

### DETAILED DESCRIPTION OF THE INVENTION

To facilitate understanding of those skilled in this field, the utility model is further described with reference to the attached drawings and the embodiments in combination.

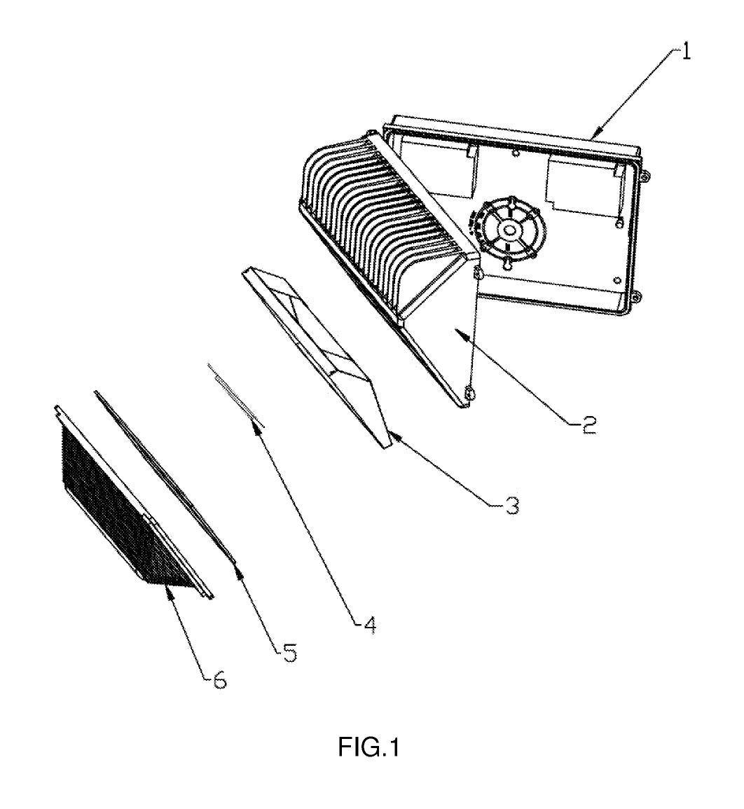

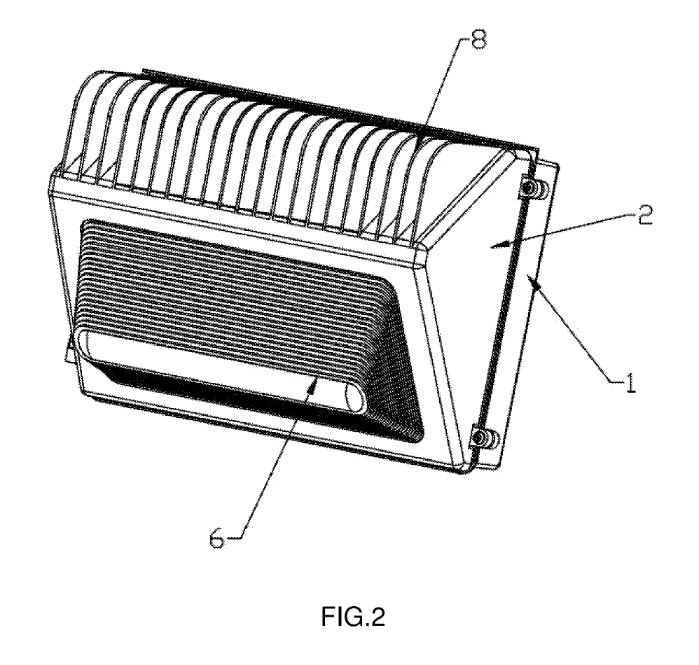

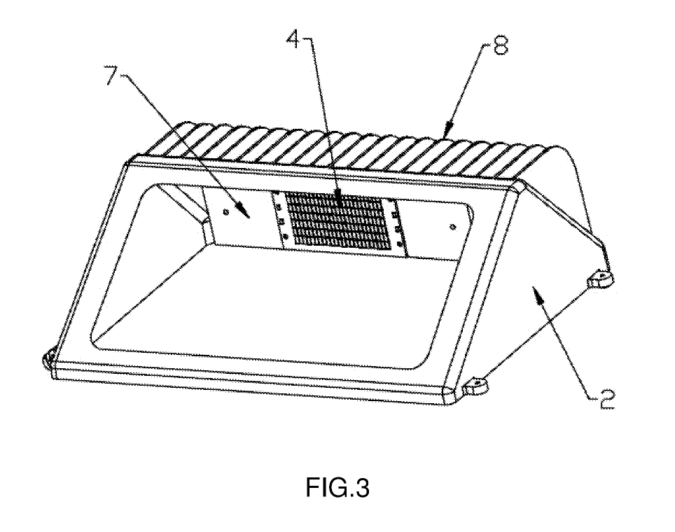

As shown in FIGS. 1, 2, 3, a novel LED wall lamp comprises a lamp frame 2 and a base plate 1 for installing electric parts; said base plate 1 is fixed on the wall; one side of said lamp frame 2 is hinged with the base plate 1, while the other side is provided with a lug in threaded connection with the base plate 1; said lamp frame 2 is cylinder with two closed ends and a hollowed interior and may be a polygon prism, semi-round cylinder, semielliptical cylinder, or others; a mounting plate 7 is provided in said lamp frame 2; the front face of the mounting plate 7 is fixed with an LED light source 4; the back of said ,mounting plate 7 is provided with dorsal fin-like heat sinks 8 exposed out of the lamp frame 2; the four sides of the mounting plate 7 are provided with reflectors 3 for correcting the whole light source; the lamp frame 2 directly in the front of the LED light source 4 has a light-emitting opening covered with a light-emitting hood 6; and a sealing ring 5 is arranged at the joint between the light-emitting hood 6 and light-emitting opening.

Said heat sinks 8 are arranged intervals, allow convective flows and therefore are of high heat dissipation.

Said heat sinks 8 and mounting plate 7 are integrally molded or separated but firmly jointed. Both the mounting plate 7 and the heat sink 8 are made of metals with high thermal conductivity, dissipating the heat generated by the LED light source 4 out of the lamp frame to keep the temperature in the lamp frame 2 within the normal working temperature scope of the LED.

The lamp frame 2 and the base plate 1 of the utility model both are structured as the traditional wall lamp. After the heat sink 8 and the mounting plate 7 are installed and assembled, the utility model is like a traditional wall lamp in the lateral view.

The LED light source 4 of the utility model may be LED chips arrayed on the base plate, large-power integrated COB, or other types.

The embodiment above cannot be regarded as a limit of the utility model. Without departing from the inventive concept of the utility model, any substitution is in the protective scope of the utility model.

What is claimed is:

1. A novel LED wall lamp, comprising a lamp frame (2) and a base plate (1) for installing electric parts, wherein said base plate (1) is fixed on the wall; one side of said lamp frame (2) is hinged with the base plate (1), while the other side is provided with a lug in threaded connection with the base plate (1); said lamp frame (2) is a cylinder with two closed ends and a hollowed interior; characterized in that: a mounting plate (7) is provided in said lamp frame (2); the front face of the mounting plate (7) is fixed with an LED light source (4); the back of said lamp frame (2) is provided with dorsal fin-like heat sinks (8) exposed out of the lamp frame (2); the four sides of the mounting plate (7) are provided with reflectors (3); the lamp frame (2) directly in the front of the LED light source (4) has a light-emitting opening covered with a light-emitting hood (6); and a sealing ring (5) is arranged at the joint between the light-emitting hood and light-emitting opening.

2. The novel LED wall lamp according to claim 1, characterized in that: said heat sinks (8) are arranged at intervals.

3. The novel LED wall lamp according to claim 2, characterized in that: said heat sinks (8), mounting plate (7) and lamp frame (2) are integrally molded or separated but firmly jointed.

4. The novel LED wall lamp according to claim 3, characterized in that: both said mounting plate (7) and heat sinks (8) are made of metals with high thermal conductivity.
